(19) United States
(12) Patent Application Publication
(10) Pub. No.: US 2005/0000194 A1
(43) Pub. Date: Jan. 6, 2005

(54) Shock absorbing saddle seat device and system

(76) Inventor: Holly Friedmann, Parkland, FL (US)

Correspondence Address: David P. Lhota;Stearns Weaver Miller, et al., Suite 1900, 200 East Broward Boulevard, Fort Lauderdale, FL, 33301, US

(21) Appl. No.: 10/826,873

(22) Filed: Apr. 16, 2004

Related U.S. Application Data
(60) Provisional application No. 60/463,670, filed on Apr. 17, 2003.

(51) Int. Cl. B68C 1/10

(52) U.S. Cl. 54/44.4

(57) ABSTRACT

A shock absorbing saddle/seat having a padded seat top, frame assembly, shock absorbers, adjustable straps and a strong fiber (nylon/fleece) cover, wherein the seat top is a thick, foam cushioned seat that rests on top of the frame assembly and together conform to the sloped seat on a traditional horse saddle.

### CROSS REFERENCE TO RELATED APPLICATIONS

This application claims the benefit of provisional patent application Ser. No. 60/463,670 filed Apr. 17, 2003.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a saddle seat, and, more particularly, to a saddle with shock absorbers that fits on top of a traditional horse saddle seat to soften the ride and alleviate the impact on a rider's body while riding.

2. Description of the Background Art

A rider experiences consistent pounding and impact forces when riding a horse. Eventually, this can lead to injuries and back problems. The shock forces also aggravate previous injuries making riding uncomfortable, especially during extended riding times. If a cost-effective device existed that could absorb some of the pounding that a body, particularly the back and neck, takes while riding it would be well received. The instant invention addresses this unfulfilled need in the prior art by providing a shock absorbing saddle attachment that reduces the stress to a rider's back and neck while providing enhanced comfort for extended riding times.

### BRIEF SUMMARY OF THE INVENTION

In light of the foregoing it is a primary object of the instant invention to provide a shock absorbing seat that absorbs pounding forces that occur while riding a horse.

It is also an object of the instant invention to provide a shock absorbing seat that reduces stress to a rider's back while riding a horse.

It is another object of the instant invention to provide a shock absorbing seat that enhances comfort while riding a horse facilitating extended riding.

Based on the foregoing, the instant invention comprises a shock absorbing saddle or seat for use when riding horses. The invention is generally referenced herein as a shock absorbing seat. The shock absorbing seats of the instant invention comprise a saddle having a thick, padded seat resting on top of a lightweight, aluminum frame that includes one of three shock absorbing systems. The shock absorbing systems comprise a plurality of shock absorbers. The seats are designed to absorb some of the pounding forces that occur while riding. The shock absorbing systems of the instant invention reduce stress to the rider's back and provide comfort for extended riding times.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of the first embodiment of the shock absorbing saddle seat device attached to a saddle in accordance with the instant invention.

FIG. 2 is a perspective view of the first embodiment of the shock absorbing saddle seat device in accordance with the instant invention.

FIG. 3 is a perspective view of the second embodiment of the shock absorbing saddle seat device in accordance with the instant invention.

FIG. 4 is a perspective view of the third embodiment of the shock absorbing saddle seat device in accordance with the instant invention.

FIG. 5 is a perspective view of the fourth embodiment of the shock absorbing saddle seat device in accordance with the instant invention.

FIG. 6 is a perspective view of the fifth embodiment of the shock absorbing saddle seat device in accordance with the instant invention.

### DETAILED DESCRIPTION OF THE INVENTION

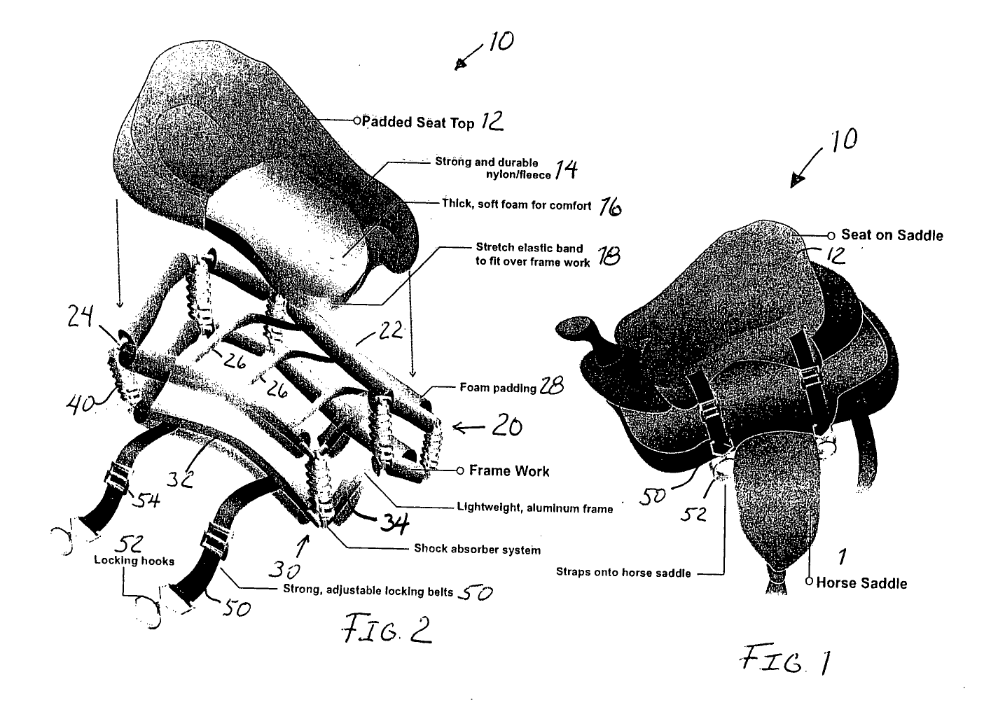

With reference to the drawings, FIGS. 1-6 depict the preferred embodiments of the instant invention which is generally referenced as a shock absorbing seat and, or by numeric characters 10, 100, 200, 300 or 400. The shock absorbing seats of the instant invention 10, 100, 200, 300, 400 each provide a saddle having a thick, padded seat resting on top of a lightweight, aluminum frame that includes one of three shock absorbing systems comprising a plurality of shock absorbers. The seats 10, 100, 200, 300, 400 are designed to absorb some of the pounding forces that occur while riding. The shock absorbing systems of the instant invention 10, 100, 200, 300, 400 reduce stress to the rider's back and provide comfort for extended riding times.

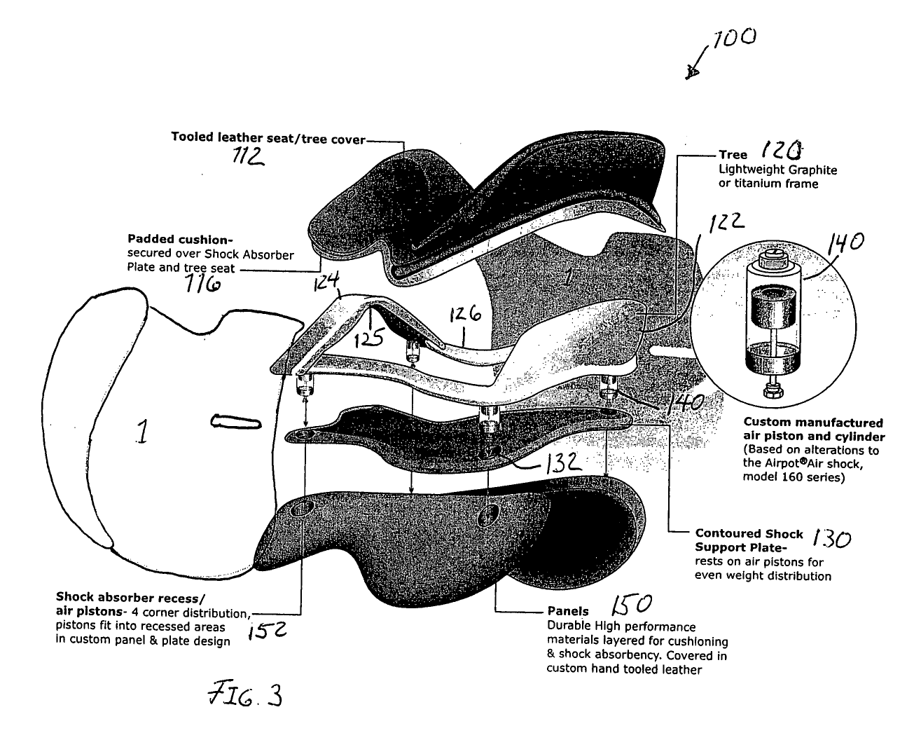

With reference to FIG. 2, the first embodiment 10 of the instant invention comprises a padded seat top 12, frame assembly 20-34, shock absorbers 30 and adjustable straps 50. The entire unit 10 is wrapped in a strong fiber (nylon/fleece) cover 14. The seat top 12 is a thick, foam cushioned seat that rests on top of the frame assembly 20-34. The seat top 12 and frame assembly 20-32 preferably resemble or conform to the sloped seat on a traditional horse saddle 1. The seat top 12 includes a strong and durable nylon or fleece cover 14, a thick, soft foam cushion 16 for comfort and framework 18 for supporting the seat top 12. The cover 14 has an elastic band around its open end that stretches and fits over the seat framework 18. The cushion 16 is form-fitted on top with two seat indentations to add comfort and support for the rider. The cover 14 comprises a tough nylon/fleece material that wraps around the cushion 16 and frames 18 and 20-34 to protect and secure the unit.

The frame assembly is preferably in the shape of a conventional saddle and comprises an upper frame 20, lower frame 30 and plurality of shock absorbers 40. The upper frame 20 comprises two long, curved sidebars 22 that extend across the length of a saddle seat and are joined by two end bars 24 and a plurality of lateral support bars 26. The frame sizes may vary to accommodate traditional saddle sizes. The end bars 24 and lateral support bars 26 comprise short, sloped rods that extend across the width of a traditional saddle. The sidebars 22, end bars 24 and lateral support bars are preferably covered with cylindrical or conforming foam padding 28. The lower frame 30 also comprises two long, curved sidebars 32 that are joined by two end bars 34. The lower frame's 30 size and shape preferably correspond to the upper frame 20. The upper and lower frames 20, 30 are joined by a plurality of shock absorbers 40. The shock absorbers 40 in the first embodiment comprise shock absorbing springs that are preferably placed at each comer and each end bar 24, 34 apex.

The shock absorbing seat 10 includes two adjustable belts, or straps 50 that are used to secure the seat 10 to a conventional saddle, such as an English or Western (traditional) saddle 1. Two adjustable belts, or straps, are preferably attached to one end of the frame and extend through openings formed in the nylon/fleece cover 14. The straps 50 include buckles 54 for adjusting the length. Round locking hooks 52 are attached to the end of each belt strap and are used to secure the shocking absorbing seat 10 to a traditional saddle 1. Once combined, the shock absorbing seat 10 and saddle 1 are strapped to a horse.

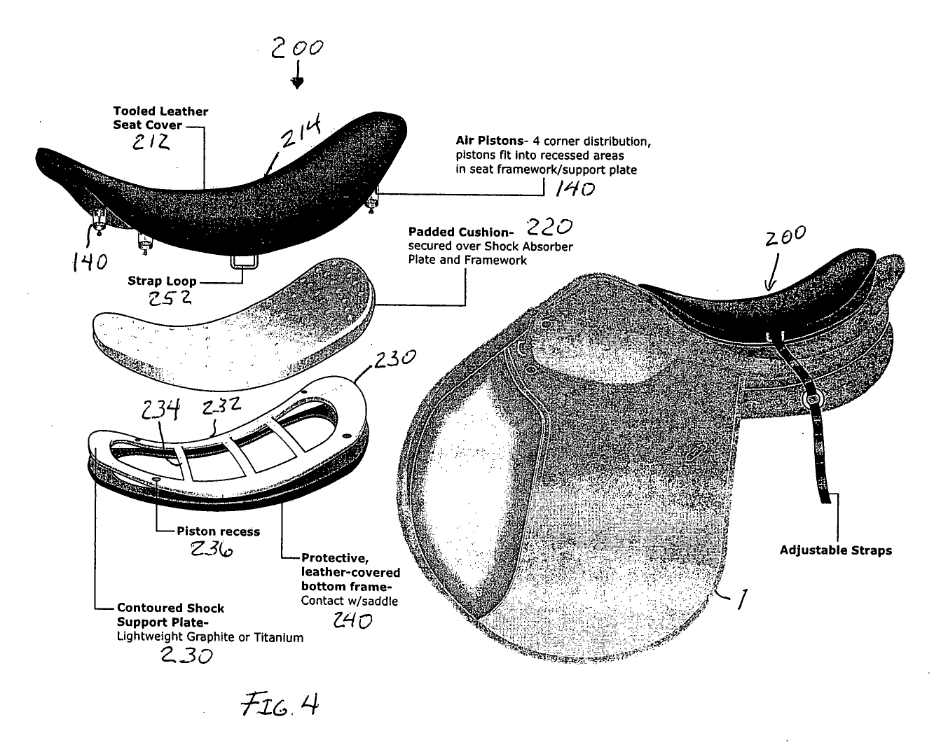

With reference to FIG. 3, the second embodiment 100 of the instant invention comprises a seat 112, frame assembly comprising a lightweight frame 120 and shock support plate 130, at least one air shock 140 and side panels 150. The seat 112 comprises tooled leather, a cover and a padded cushion 116. The seat 112 is supported on the frame assembly. The frame 122 is manufactured from a lightweight graphite or titanium material and is contoured to complement the shape of a conventional saddle. The frame 122 comprises an upper plate section 122 joined to a thinner lower plate section 124 by two opposing side arms 126. The frame 122 preferably comprises a unibody construction. The upper plate 122 rises at a contoured angle and the lower plate 124 defines a substantially centrally located apex 125. The sidebars 126 have a length and shape that corresponds to the length and shape of a conventional saddle 1. The shock support plate 130 fits below the frame 120 and comprises a contoured shape that is similar and structurally complimentary to the frame 122. The support plate 130 has a plurality of apertures 132 preferably positioned proximal the corners for receiving the air shocks 140. The air shocks 140 preferably comprise those manufactured and sold under the trademark Airpot and model 160 series. The air shocks 140 are connected or engaged at one end to the frame 122 and at an opposite end to the side panels 150. The side panels 150 have a corresponding number of recessed slots 152 for receiving and securing the air shocks 140. The side panels 150 depend from the frame assembly and comprise durable high performance materials layered for cushioning and shock absorbency. The side panels 150 are covered in a custom hand tooled leather. The second embodiment 100 may also include securable straps.

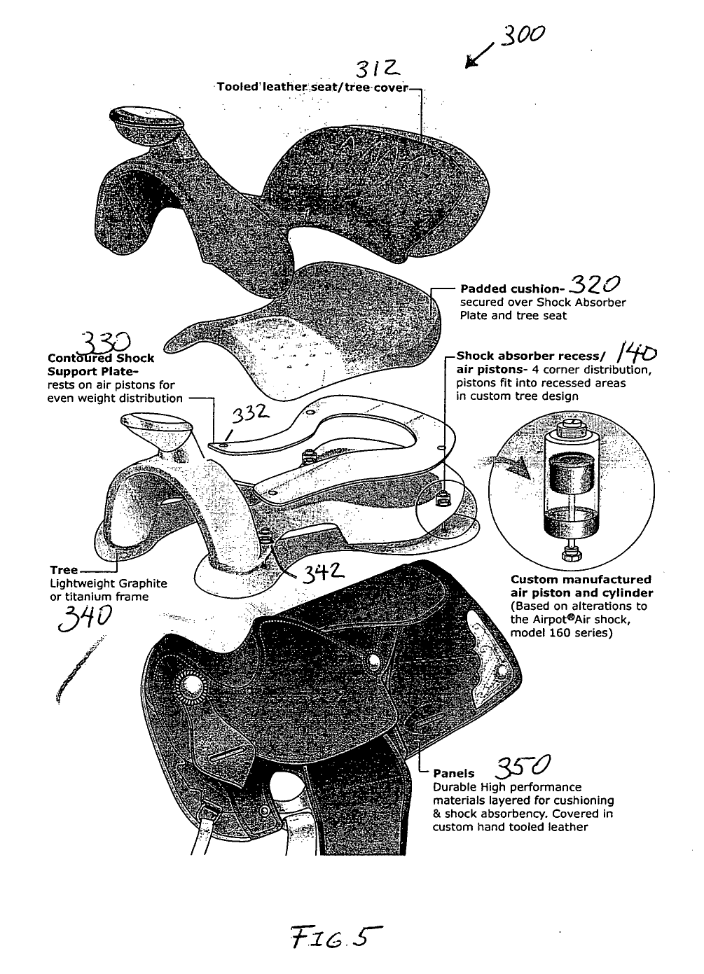

With reference to FIG. 4, the third embodiment 200 comprises a seat 212, padded cushion 220, shock support plate 230, frame 240 and air shocks 140. The seat 212, cushion 220, support plate 230 and frame 240 are preferably contoured to compliment and accommodate conventional saddles 1. The seat 212 comprises a leather seat cover 214 and at least one strap loop 252. The padded cushion 220 is secured over the shock absorber plate 230 and frame 240. The support plate 230 preferably comprises a unibody construction and has a main outer frame 232 and a plurality of lateral support members 234. The outer frame 232 has a plurality of apertures 236 positioned for receiving the air shocks 140. The frame 240 comprises a lower support plate having a protective leather cover for engaging the saddle 1.

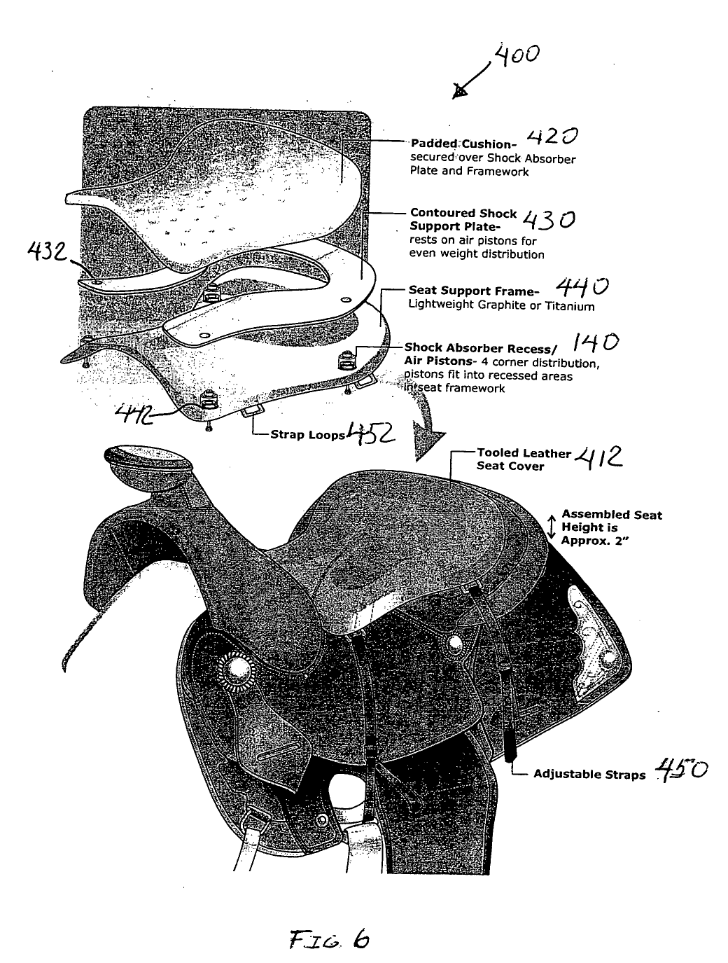

With reference to FIG. 5, the fourth embodiment 300 comprises a tooled leather seat/tree cover 312, padded cushion 320, contoured shock support plate 330, lightweight graphite or titanium frame 340, and at least one air shock 140. The padded cushion 320 is secured over the shock absorber plate 330 and tree seat frame 340. The contoured shock support plate 330 rests on the air shocks/pistons 140 for even weight distribution. The plate 330 includes a plurality of apertures 332 corresponding to the number and positioning of air shocks 140. The seat/tree frame 340 is made from titanium or graphite, is shaped like a saddle and has a plurality of apertures 342 corresponding to the number of air shocks 140. The apertures 332, 342 receive the air shocks 140. The fourth embodiment may also include leather-covered panels 350 made from a durable high performance material layered for cushioning and shock absorbency.

With reference to FIG. 6, the fifth embodiment 400 comprises a padded cushion 420, contoured support plate 430, seat support frame 440, and air shocks 140. The padded cushion 420 fits and are secured over the shock absorber plate 430 and support frame 440. The contoured shock support plate 430 rests on the air shocks/pistons 140 for even weight distribution and has a plurality of apertures 432 for receiving the air shocks 140. The seat support frame 440 is made from a lightweight graphite or titanium and has a plurality of apertures 442 for receiving the air shocks 140. The support frame 440 may also include at least one strap loop 452. The fifth embodiment 400 may also have adjustable straps 450.

The shock absorbing seat 10, 100, 200, 300, 400 may be manufactured as an after market accessory or as a saddle having the shock absorbing assembly built into it. The frame assembly bars in the first embodiment are preferably constructed from a heavy-duty, durable and lightweight aluminum. The seat 12 in the first embodiment preferably comprises a durable nylon/fleece seat wrap 14, a thick foam seat cushion 16, nylon straps 50 and industrial grade metal locking hooks 52. The second embodiment 100 preferably has a leather seat 112 and graphite or titanium frame 120. The third, fourth and fifth embodiments 200, 300, 400 preferably have leather seats, foam or padded cushions, and titanium or graphite support plates.

The instant invention is adapted for use by novice and experienced horse riders. To use the instant invention, the rider places the shock-absorbing seat 10, 10 or 200 on top of the saddle 1, preferably an English or Western style saddle, secures locking belts or similar fasteners around the saddle 1 tightly, and saddles the horse as normal. When the ride is finished, the shock-absorbing seat 10, 100, 200 is removed from the saddle 1 by unlocking the fasteners.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

1. A shock absorbing saddle for use in horse-back riding, said saddle comprising:
a frame assembly;
a padded seat secured to said frame assembly;
said frame assembly having a shock absorbing system;
said shock absorbing system comprises means for absorbing shock; and
means for securing said frame assembly to a horse.

2. A saddle as recited in claim 1, further comprising:
a fabric-based cover; and
means for securing said cover to said padded seat.

3. A saddle as recited in claim 1, wherein said means for absorbing shock comprises:
a plurality of shock absorbing springs.

4. A saddle as recited in claim 1, wherein said means for absorbing shock comprises:
a plurality of shock absorbing air pistons.

5. A saddle as recited in claim 1, wherein said frame assembly comprises:
an upper frame comprising a plurality of rods operatively joined together;
a lower frame comprising a plurality of rods operatively joined together, said means for absorbing shock extending between said lower frame and said upper frame joining said frames together.

6. A saddle as recited in claim 5, wherein said means for absorbing shock comprises:
a plurality of shock absorbing springs.

7. A saddle as recited in claim 5, wherein said means for absorbing shock comprises:
a plurality of shock absorbing air pistons.

8. A saddle as recited in claim 1, wherein said frame assembly comprises:
an upper plate;
a lower plate, said means for absorbing shock extending between said lower plate and said upper plate joining said plates together.

9. A saddle as recited in claim 8, wherein said means for absorbing shock comprises:
a plurality of shock absorbing air pistons.

10. A saddle as recited in claim 1, wherein said padded seat comprises a cushion.

11. A saddle as recited in claim 1, wherein said frame assembly further comprises foam padding.

12. A saddle as recited in claim 1, wherein said padded seat fits over said frame assembly.

13. A saddle as recited in claim 1, wherein said frame assembly and padded seat comprise contours that adapt to the contours of a horse back.
